(19) United States
(12) Patent Application Publication
(10) Pub. No.: US 2022/0237485 A1
(43) Pub. Date: Jul. 28, 2022

(54) PRINTING A PORTION OF A WEB PAGE USING ARTIFICIAL INTELLIGENCE

(71) Applicant: KYOCERA Document Solutions Inc., Osaka (JP)

(72) Inventor: Eric Pugh, Torrance, CA (US)

(21) Appl. No.: 17/161,603

(22) Filed: Jan. 28, 2021

(51) Int. Cl. G06N 5/04; G06N 20/00; G06F 16/9535

(52) U.S. Cl. CPC G06N 5/04; G06F 16/9535; G06N 20/00

(57) ABSTRACT

Apparatuses and methods relating generally to printing are described. In an example method thereof, content of a web page is collected by an artificial intelligence (“AI”) engine. The collecting includes accessing at least one store of historical data by the AI engine to parse components of the content. The components are parsed with a parser. The AI engine determines exclusion of one or more of the components responsive to the historical data to provide page data. The page data is printed. Furthermore, in an example apparatus thereof, a programmable electronic device is configured to initiate operations to provide a print function call for printing page data with driver-generated content. The page data is a subset of primitives of a web page, and an AI engine is configured to remove one or more of the primitives of the web page to provide the subset thereof.

### FIELD

The following description relates to printing. More particularly, the following description relates to printing a portion of a web page using artificial intelligence.

### BACKGROUND

Conventionally, when a web page is printed, a substantial amount of unwanted information is printed with the information targeted for printing. This can waste printing resources.

### SUMMARY

In accordance with one or more below described examples, a method relating generally to an information processing system is disclosed. In such a method, a content of a web page is collected by an artificial intelligence engine. The collecting includes accessing at least one store of historical data by the artificial intelligence engine to parse components of the content. The components are parsed with a parser. The artificial intelligence engine determines to exclude one or more of the components responsive to the historical data to provide page data. The page data is printed.

In accordance with one or more below described examples, an apparatus relating generally to a programmable electronic device is disclosed. In such a system, a memory is configured to store program code including a printer driver for a printing device. A data store is configured to store historical data. A processor is coupled to the memory and the data store. The processor, in response to executing the printer driver, is configured to initiate operations to provide a print function call for printing page data with driver-generated content. The page data is a subset of primitives of a web page. The artificial intelligence engine is configured to collect content of the web page and remove one or more of the primitives of the web page to provide the subset thereof. The artificial intelligence engine is configured to access the data store to use the historical data to parse components of the content by types of the primitives.

In accordance with one or more below described examples, another apparatus relating generally to an information processing system is disclosed. In such a system, a memory is configured to store program code. A processor is coupled to the memory. The processor, in response to executing the program code, is configured to initiate operations for implementing a print of a portion of a web page. The operations include collecting content of the web page by an artificial intelligence engine. The collecting includes accessing at least one store of historical data by the artificial intelligence engine to parse components of the content. The operations further include: parsing the components with a parser; determining exclusion of one or more of the components responsive to the historical data by the artificial intelligence engine to provide page data; and printing the page data as a portion of the web page.

Other features will be recognized from consideration of the Detailed Description and Claims, which follow.

### BRIEF DESCRIPTION OF THE DRAWINGS

Accompanying drawings show exemplary apparatus(es) and/or method(s). However, the accompanying drawings should not be taken to limit the scope of the claims, but are for explanation and understanding only.

FIG. 1 is a flow-block diagram depicting an example of an information processing system flow.

FIG. 2 is a block-flow diagram depicting an example of components of an information processing system for the information processing system flow of FIG. 1.

FIG. 3-1 is a flow-block diagram depicting an example of a demographic data updating flow.

FIG. 3-2 is a flow-block diagram depicting an example of another demographic data updating flow.

FIG. 4 is a pictorial diagram depicting an example of a network.

FIG. 5 is block diagram depicting an example of a portable communication device.

FIG. 6 is a block diagram depicting an example of a multi-function printer (“MFP”).

FIG. 7 is a block diagram depicting an example of a computer system/MFP.

### DETAILED DESCRIPTION

In the following description, numerous specific details are set forth to provide a more thorough description of the specific examples described herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same number labels are used in different diagrams to refer to the same items; however, in alternative examples the items may be different.

Exemplary apparatus(es) and/or method(s) are described herein. It should be understood that the word “exemplary” is used herein to mean “serving as an example, instance, or illustration.” Any example or feature described herein as “exemplary” is not necessarily to be construed as preferred or advantageous over other examples or features.

Before describing the examples illustratively depicted in the several figures, a general introduction is provided to further understanding.

As previously indicated, printing of a web page can involve printing a substantial amount of extraneous or unwanted information to be included in such a print. As described below in additional detail, an artificial intelligence engine is used to remove one or more objects or primitives of such a web page to streamline information printed, namely to print only a portion but not all of such web page. Along those lines, one or more primitives of such web page are removed or slated for removal by such artificial intelligence engine.

With the above general understanding borne in mind, various configurations for artificial intelligence engine assisted printing apparatuses, systems, and methods therefor, with capabilities for removal or identification for removal of one or more primitives are generally described below.

Reference will now be made in detail to examples which are illustrated in the accompanying drawings. In the following detailed description, numerous specific details are set forth in order to provide a thorough understanding of the following described implementation examples. It should be apparent, however, to one skilled in the art, that the implementation examples described below may be practiced without all the specific details given below. Moreover, the example implementations are not intended to be exhaustive or to limit scope of this disclosure to the precise forms disclosed, and modifications and variations are possible in light of the following teachings or may be acquired from practicing one or more of the teachings hereof. The implementation examples were chosen and described in order to best explain principles and practical applications of the teachings hereof to enable others skilled in the art to utilize one or more of such teachings in various implementation examples and with various modifications as are suited to the particular use contemplated. In other instances, well-known methods, procedures, components, circuits, and/or networks have not been described in detail so as not to unnecessarily obscure the described implementation examples.

For purposes of explanation, specific nomenclature is set forth to provide a thorough understanding of the various concepts disclosed herein. However, the terminology used herein is for the purpose of describing particular examples only and is not intended to be limiting. As used herein, the singular forms “a”, “an” and “the” are intended to include the plural forms as well, unless the context clearly indicates otherwise. As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. It will also be understood that the term “and/or” as used herein refers to and encompasses any and all possible combinations of one or more of the associated listed items. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof. It will also be understood that, although the terms first, second, etc. may be used herein to describe various elements, these elements should not be limited by these terms, as these terms are only used to distinguish one element from another.

Some portions of the detailed descriptions that follow are presented in terms of algorithms and symbolic representations of operations on data bits, including within a register or a memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those involving physical manipulations of physical quantities. Usually, though not necessarily, these quantities take the form of optical, electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

Concepts described herein may be embodied as apparatus, method, system, or computer program product. Accordingly, one or more of such implementation examples may take the form of an entirely hardware implementation example, an entirely software implementation example (including firmware, resident software, and micro-code, among others) or an implementation example combining software and hardware, and for clarity any and all of these implementation examples may generally be referred to herein as a “circuit,” “module,” “system,” or other suitable terms. Furthermore, such implementation examples may be of the form of a computer program product on a computer-usable storage medium having computer-usable program code in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CD-ROM”), an optical storage device, a transmission media such as those supporting the Internet or an intranet, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (“RF”) or other means. For purposes of clarity by way of example and not limitation, the latter types of media are generally referred to as transitory signal bearing media, and the former types of media are generally referred to as non-transitory signal bearing media.

Computer program code for carrying out operations in accordance with concepts described herein may be written in an object-oriented programming language such as Java, Smalltalk, C++ or the like. However, the computer program code for carrying out such operations may be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (“LAN”) or a wide area network (“WAN”), or the connection may be made to an external computer (for example, through the Internet using an Internet Service Provider).

Systems and methods described herein may relate to an apparatus for performing the operations associated therewith. This apparatus may be specially constructed for the purposes identified, or it may include a general-purpose computer selectively activated or reconfigured by a computer program stored in the computer.

Notwithstanding, the algorithms and displays presented herein are not inherently related to any particular computer or other apparatus. Various general-purpose systems may be used with programs in accordance with the teachings herein, or it may prove convenient to construct a more specialized apparatus to perform the operations. In addition, even if the following description is with reference to a programming language, it should be appreciated that any of a variety of programming languages may be used to implement the teachings as described herein.

One or more examples are described below with reference to flowchart illustrations and/or block diagrams of methods, apparatus (including systems) and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of apparatuses (including systems), methods and computer program products according to various implementation examples. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

It should be understood that although the flow charts provided herein show a specific order of operations, it is understood that the order of these operations may differ from what is depicted. Also, two or more operations may be performed concurrently or with partial concurrence. Such variation will depend on the software and hardware systems chosen and on designer choice. It is understood that all such variations are within the scope of the disclosure. Likewise, software and web implementations may be accomplished with standard programming techniques with rule-based logic and other logic to accomplish the various database searching operations, correlation operations, comparison operations and decision operations. It should also be understood that the word “component” as used herein is intended to encompass implementations using one or more lines of software code, and/or hardware implementations, and/or equipment for receiving manual inputs.

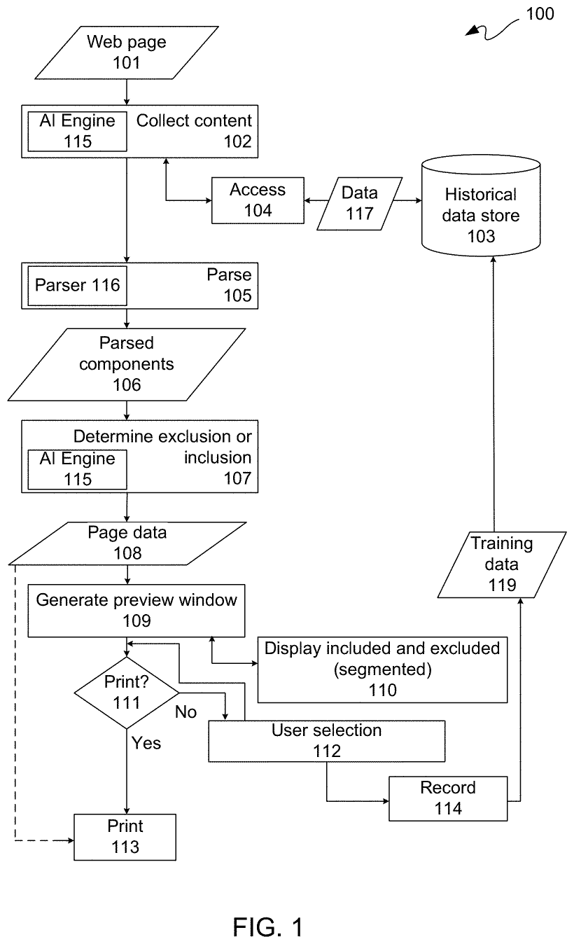

FIG. 1 is a flow-block diagram depicting an example of an information processing system flow 100. At operation 102, content of a web page 101 may be collected by an artificial intelligence (“AI”) engine 115. An example of AI engine 115 may be an autonomous machine from Nvidia, a programmed Intel AI multi-core processor, or other programmed AI platform. However, for this example, an AI software or firmware application may be used for AI engine 115. However, generally AI engine 115 may be provided in hardware, software, or a combination thereof.

AI engine 115 may be configured for deep learning, generative learning, or generative deep learning. Supervised learning as a form of deep learning may be used. Generally, in supervised learning, input variables and output variables may be present, and an algorithm is used to learn one or more mapping functions from input to output. In the example below, historical data with respect to a web page may be used to determine such mapping functions.

Along those lines, there are different forms of supervised learning for AI. For example, there is image segmentation and object segmentation in supervised learning.

AI engine 115 may be configured for unsupervised learning as another branch of AI deep learning. In unsupervised learning, transformations of input data may be found without any targets such as for data visualization, data compression, data denoising, or to better understand data correlations. Dimensionality reduction and clustering are known categories of unsupervised learning.

Generative learning is a class of models for unsupervised learning. In generative learning, training data is used to generate new samples from data distribution of such training data. In the following example, generative learning is used, as a significant amount of data in a domain is collected, and then a model is trained to generate data like such data. This allows generative models to learn natural features of a dataset.

Collecting operation 102 may include an accessing operation 104. Collecting operation 102 may be for obtaining training data. Accessing operation 104 may include requesting, and receiving in response, historical data 117 from at least one historical data store 103, such as a database or knowledge base for example, by AI engine 115. AI engine 115 may use historical data 117 to parse components of content of a web page 101. Historical data 117 may be associated with web page 101, web pages similar to web page 101, or other data, and how such data was treated for purposes of printing.

Content of a web page may include one or more primitives or hypertext markup language (“HTML”) elements. For example, JavaScript (“JS”) primitives include primitive value and primitive data type. Examples of JS primitive data types include string, number, bigint, Boolean, undefined, symbol, and sometimes null.

At operation 105, collected content from web page 101, which includes components 106, may be parsed by a parser 116. In this example, an HTML5 parser is used for a parser 116; however, another type of parser may be used in another example. However, to enhance performance, an HTML5 parser may be used to provide speculative parsing, namely continued parsing of a document or web page while scripts are being downloaded and executed. Parsing may be used to identify types of components, such as what primitive type a component is. Accordingly, historical data may be used to parse content of a web page, such as components thereof, according to primitive types.

Generally, a parser is a component of a web or other browser. For example, a parser may control how HTML source code is turned into a web page 101, or more than one web page. There may be many different types of components to a web page 101, as a web page may present text, images, video streams, links to video streams, links to other content, advertising content, encrypted content, and/or frames to divide such a web page, among other types of components.

In another example, parsing operation 105 may be performed before collecting operation 102 in order to avoid an additional parsing operation. However, for purposes of clarity, it is assumed for information processing system flow 100 of FIG. 1 that any parsing for collecting operation 102 is performed in advance of a separate follow-on parsing operation 105.

After parsing components 106 of a web page 101, at operation 107, it may be determined by AI engine 115 which one or more of such components 106 are to be excluded, and thus which remaining items are to be included. AI engine 115 may use retrieved historical data 117 for training to determine a model, and thus use such historical data-based model to determine relative importance of parsed components 106 to provide page data 108 associated with web page 101. Additionally, at operation 107, AI engine 115 may determine inclusion of one or more other components responsive to historical data using such historical data-based model to provide page data 108.

At operation 107, page data 108 items may be tagged by AI engine 115, where AI engine 115 tags each such item for either inclusion or exclusion from a subsequent printing operation. In another example, AI engine 115 may utilize historical data 117 to remove one or more primitives and/or objects (“primitives”) for providing a graphical view of each primitive remaining in page data 108. Along those lines, page data 108 may be a subset of primitives of all primitives of web page 101, namely a portion but not all of a web page 101.

This graphical view may be presented or displayed on display device in an application window. However, after determining page data 108 items to be excluded, AI engine 115 may optionally proceed directly to printing operation 113 for printing web page 101 content without any and all AI engine 115 items determined to be excluded.

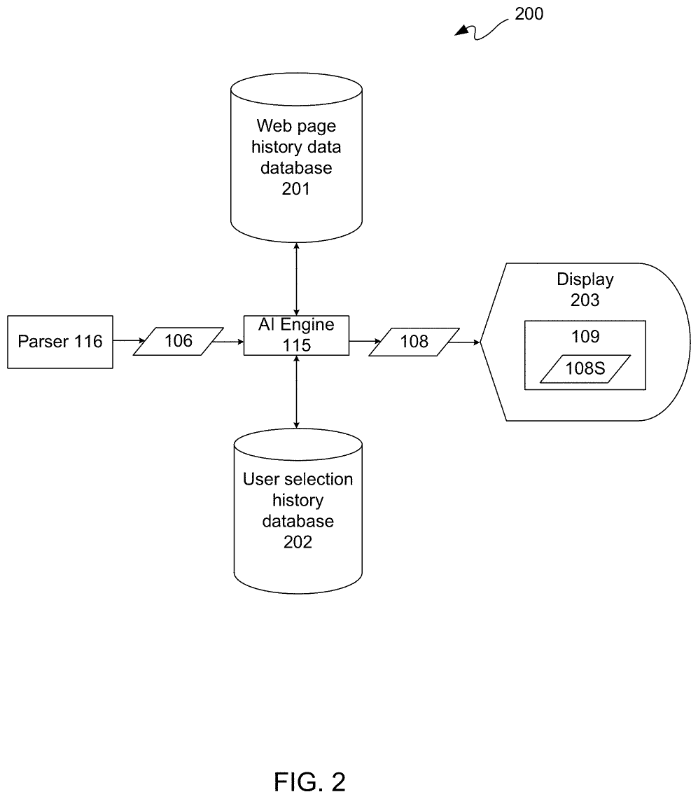

FIG. 2 is a block-flow diagram depicting an example of components of an information processing system 200 for information processing system flow 100 of FIG. 1. Information processing system 200 components of FIG. 2 are described in additional detail with simultaneous reference to FIGS. 1 and 2.

AI engine 115 may be in communication with a web page history data base 201 and a user selection history database 202. Parser 116 may provide parsed components 106 of a web page 101 to AI engine 115. AI engine 115 may use parsed components 106 as indices to access data in web page history data base 201 and in user selection history database 202.

Using generative learning, AI engine 115 may be programmed to exclude information from parsed components 106, and optionally to add information to parsed components, based on retrieved data from either or both of databases 201 and/or 202. Based on decisions made by AI engine 115, AI engine 115 may output page data 108 for display on display 203, such as in a preview window 109 with user selectable page data 108S as part of a user interface (“UI”).

Along those lines, AI engine 115 may open a preview window 109. Preview window 109 may be a print preview window. In another example, an initial print preview window 109 may be generated for printing a web page 101 with selectable content, or such initial print preview window 109 may be updated with page data 108 by AI engine 115 with selectable content.

Returning to FIG. 1, assuming user intervention is being used, such as during a training phase for example, at operation 109, a preview window may be generated for display on a display device, such as for a human user or a machine vision user, or for consumption by another AI engine, such as a supercomputer AI. Along those lines, even though the following example is in terms of a human user, such a user may be a more powerful AI engine than special purpose AI engine 115, as special purpose AI engine 115 is for printing of web page content.

Such a preview window may include a display of page data 108. Along those lines, such a preview window may include a display operation 110 to display content to be excluded in a subsequent printing operation. Furthermore, display operation 110 may display both included content and content to be excluded upon printing.

Many ad items on a web page for example may have encrypted information, such as encrypted links. This, and possibly other encrypted information, may be flagged for exclusion by AI engine 115. Furthermore, AI engine 115 may through generative learning learn to summarily exclude all encrypted information. In other words, AI engine 115 may obtain a learned behavior to exclude encrypted information.

Such display at operation 110 may have page data 108 displayed as segmented items for selection by a user. For example, text may be segmented from an image, whether these separate items are not related, such as for example an ad image and a separate article, or related, such as for example an image included as part of an article. In such displaying of a preview window on a display device with user selectable items, such user selectable items may be addable or removable from page data 108, such as responsive to cursor pointing device positioning and selection.

At operation 111, a user may be presented with a choice as whether to print page data 108 without items tagged as to be excluded. If a user either or both wants to include one or more excluded items or exclude one or more included items from a subsequent print operation, a user may select NO for entering into a user selection operation 112.

In a user selection operation 112, one or more excluded items of page data 108 may be selected for inclusion, and/or one or more included items of page data 108 may be selected for exclusion. As part of user selection operation 112, each such selection for inclusion or deselection for exclusion may be recorded at operation 114 for training data 119 for storage in historical data store 103. Such recorded training data 119 may be stored in association with historical data 117.

Additionally, a user at operation 112 may decide to include one or more non-page data 108 items. For example, a user may decide to include one or more annotations, items from another web page or another source, or other content.

Historical data 117 for example may include browsing history with respect to web page 101. However, historical data 117 may include one or more other user interactions, including selections, with respect to printing web page 101. Accordingly, browsing history of historical data 117 may include one or more items of current data of web page 101, type of web page 101, and/or uniform resource locator (“URL”) information of web page 101.

Historical data 117 may include generative-learning data including user data, which may include current and prior user actions. For example, user data, which may include user metadata, may include current and prior selection data including type of objects removed and/or type of objects added. This generative-learning data 119 generated at operation 111 may be recorded at operation 114.

Furthermore, even though generative-learning or training data 119 may be included as part of a body of knowledge regarding a web page 101, such generative-learning or training data 119 may optionally be recorded as specific to a user as user data. In either or both instances, user data may include current and prior selection data, including type of each object removed and type of each object added, and such user data may be catalogued by AI engine 115 for storage in historical data store 103.

After a user selection operation 112, a user may be asked again whether to print page data 108, such as after editing by a user. If, at operation 111, a user selects YES to print current page data 108, then a printing operation 113 may be performed by a printing device, such as a multi-function printer or a standalone printer, as an example of an information processing system.

Accordingly, a user may be able to more readily tailor what content is to be printed from a web page. Facilitating this tailored printing may avoid unwanted printings saving time, materials, and wear on a printing device.

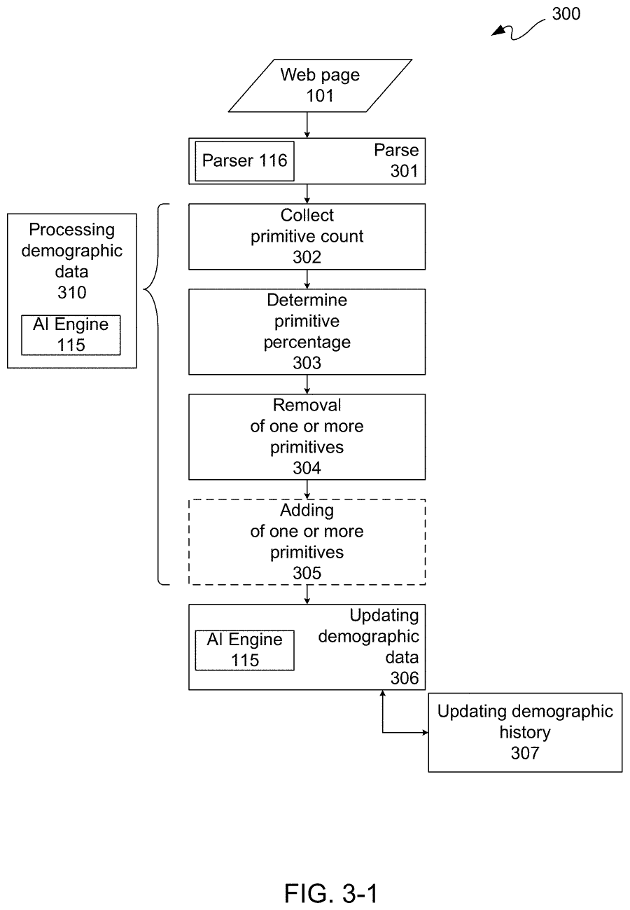

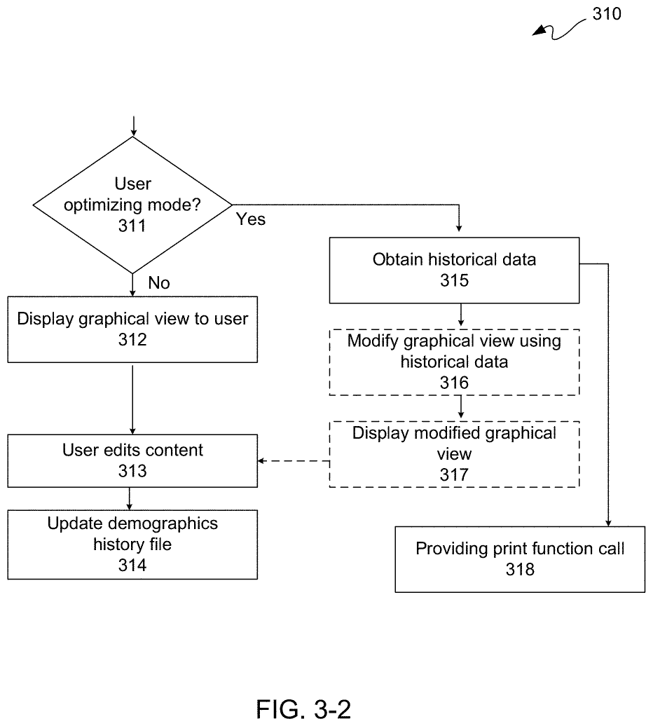

FIG. 3-1 is a flow-block diagram depicting an example of a demographic data updating flow 300. Demographic data updating flow 300 is further described with simultaneous reference to FIGS. 1 through 3-1.

At operation 301, parser 116 may parse primitives of a web page 101. This parsing operation may be part of a collection of content operation 102.

With parsed primitives of a web page 101, AI engine 115 may process demographic data, including per primitive type, of web page 101 at operation 310. Processing operation 310 may be part of a collection of content operation 102. Processing operation 310 may include operations 302 through 304, and optionally operation 305.

At operation 302, AI engine 115 may collect or determine a primitive count for parsed primitives of web page 101. Such a primitive count may include counting primitives per type and in total. At operation 303, AI engine may collect or determine a primitive percentage per type with reference to a total amount of web page 101 consumed by primitives.

At operation 304, AI engine 115 using generative learned behavior may remove one or more primitives of parsed primitives of a web page 101. Such removal operation may be part of operation 107.

Optionally, at operation 305, AI engine 115 using generative learned behavior may add one or more primitives from database 201 and/or 202. Such optional addition operation may be part of operation 107.

At operation 306, AI engine 115 may communicate with historical data store 103 for updating or adding demographic data associated with web page 101. Updating operation 306 may include updating a demographics history responsive to removal of one or more of primitives at operation 304, and optionally addition of one or more primitives at operation 305. Such updating may be included in training data 119.

FIG. 3-2 is a flow-block diagram depicting an example of another demographic data updating flow 310. Demographic data updating flow 310 is further described with simultaneous reference to FIGS. 1 through 3-2.

At operation 311, it may be determined whether a user optimizing mode has been set or activated. If, at operation 311, it is determined that a user optimizing mode, such as of a printing device driver, has not been activated, then at operation 312 a graphical view of web page primitives may be presented to a user, such as on a display coupled to or part of a computer system or other electronic machine. Such a display may be a print preview generated by a printer driver for a printing device, where such print preview includes user selectable content, namely user selectable parsed primitives of a web page 101.

At operation 313, a user may edit content of such a generated preview. As previously described, such editing may include removal of one or more primitives, and optionally addition of one or more primitives. At operation 314, a demographics history file may be updated, such as in historical data store 103, responsive to any and all edits at operation 313. An updated demography may be used for purposes of training AI engine 115, such as for use in generative learning.

If, however, at operation 311 it is determined that a user optimizing mode has been set or activated, such as in a printer driver, then at operation 315, historical data may be obtained, such as from historical data store 103 by AI engine 115. Along those lines, an AI engine 115 may be included in a printer driver.

AI engine 115 optionally may modify a graphical view, such as a print preview, at operation 316 using graphical data obtained at 315. Optionally, at operation 317, such a modified graphical view may be displayed, such as to a user, and, optionally, a user may have the option of editing content at operation 313 in such a modified graphical view.

After utilizing historical data by AI engine 115 to remove one or more primitives for providing a graphical view of each primitive remaining in page data, such and then presenting such a graphical view on a display device in an application window, a user may edit such graphical view at operation 313 as previously described. However, operations 316 and 317 may be bypassed, and operation 313, and thus operation 314, may be avoided, by providing a print function call by a printer driver at operation 318. Such a print function call may be for printing page data as edited by AI engine 115, including removal of one or more primitives, with driver-generated content.

Driver-generated content may depend upon an emulator type selected. Examples of emulator types include postscript, pdf, or another emulation language. Accordingly, driver-generated content may include taking remaining primitives, namely page data, and converting such primitives into an emulator stream in an emulator language.

Because one or more of the examples described herein may be implemented in using an information processing system, a detailed description of examples of each of a network (such as for a Cloud-based SaaS implementation), a computing system, a mobile device, and an MFP is provided. However, it should be understood that other configurations of one or more of these examples may benefit from the technology described herein.

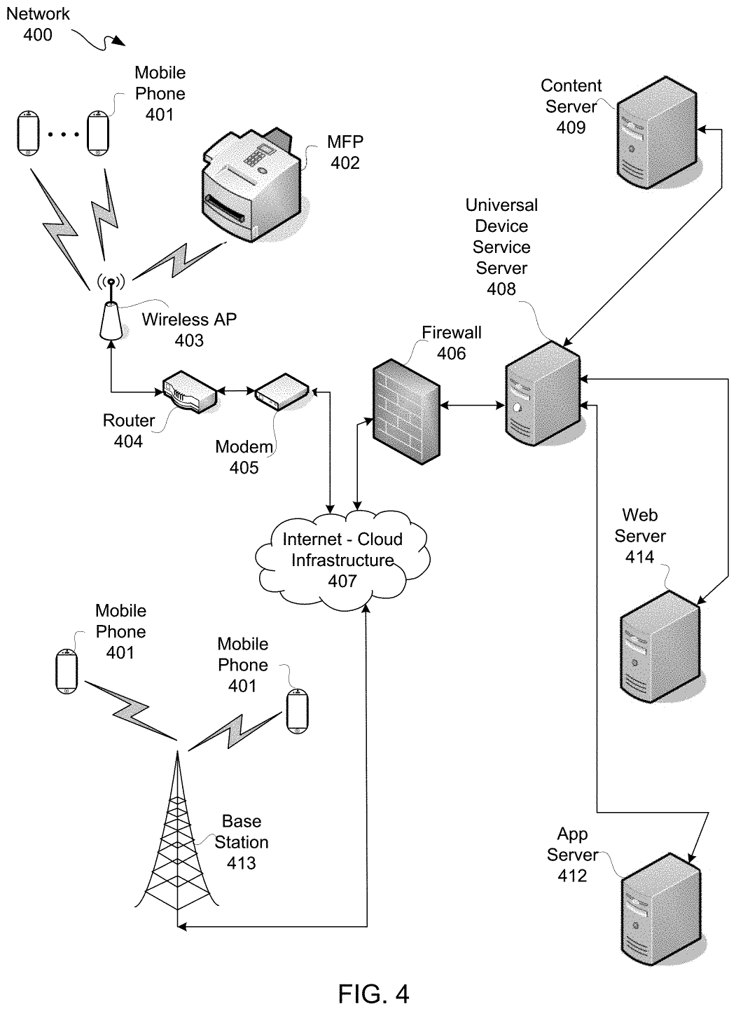

FIG. 4 is a pictorial diagram depicting an example of a network 400, which may be used to provide a SaaS platform for hosting a service or micro service for use by a user device, as described herein. Along those lines, network 400 may include one or more mobile phones, pads/tablets, notebooks, and/or other web-usable devices 401 in wired and/or wireless communication with a wired and/or wireless access point (“AP”) 403 connected to or of a wireless router. Furthermore, one or more of such web-usable wireless devices 401 may be in wireless communication with a base station 413. Additionally, a desktop computer and/or a printing device, such as for example a multi-function printer (“MFP”) 402, each of which may be web-usable devices, may be in wireless and/or wired communication to and from router 404.

Wireless AP 403 may be connected for communication with a router 404, which in turn may be connected to a modem 405. Modem 405 and base station 413 may be in communication with an Internet-Cloud infrastructure 407, which may include public and/or private networks.

A firewall 406 may be in communication with such an Internet-Cloud infrastructure 407. Firewall 406 may be in communication with a universal device service server 408. Universal device service server 408 may be in communication with a content server 409, a web server 414, and/or an app server 412. App server 412, as well as a network 400, may be used for downloading an app or one or more components thereof for accessing and using a service or a micro service as described herein.

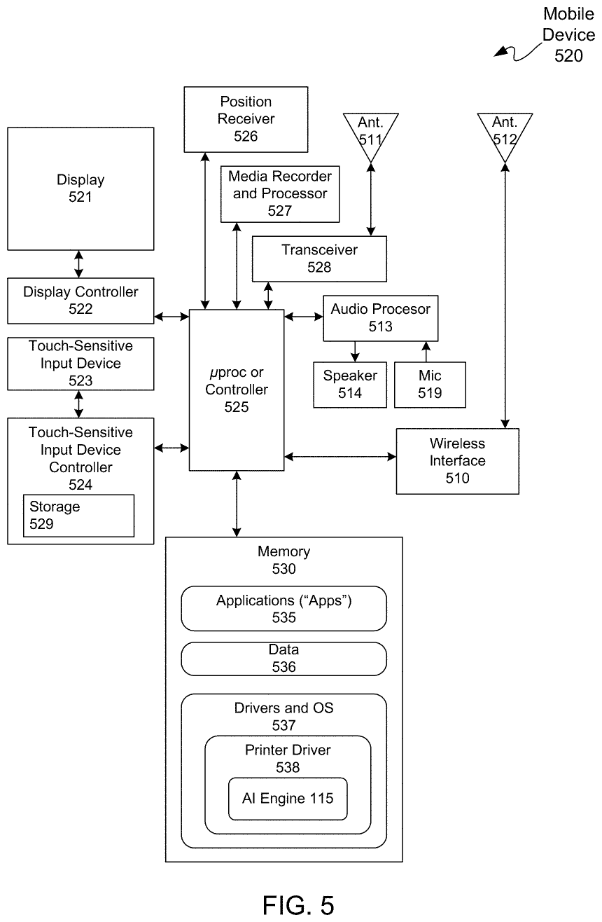

FIG. 5 is block diagram depicting an example of a portable communication device (“mobile device”) 520. Mobile device 520 may be an example of a mobile device, as previously described.

Mobile device 520 may include a wireless interface 510, an antenna 511, an antenna 512, an audio processor 513, a speaker 514, and a microphone (“mic”) 519, a display 521, a display controller 522, a touch-sensitive input device 523, a touch-sensitive input device controller 524, a microprocessor or microcontroller 525, a position receiver 526, a media recorder and processor 527, a cell transceiver 528, and a memory or memories (“memory”) 530.

Microprocessor or microcontroller 525 may be programmed to control overall operation of mobile device 520. Microprocessor or microcontroller 525 may include a commercially available or custom microprocessor or microcontroller.

Memory 530 may be interconnected for communication with microprocessor or microcontroller 525 for storing programs and data used by mobile device 520. Memory 530 generally represents an overall hierarchy of memory devices containing software and data used to implement functions of mobile device 520. Data and programs or apps as described hereinabove may be stored in memory 530.

Memory 530 may include, for example, RAM or other volatile solid-state memory, flash or other non-volatile solid-state memory, a magnetic storage medium such as a hard disk drive, a removable storage media, or other suitable storage means. In addition to handling voice communications, mobile device 520 may be configured to transmit, receive and process data, such as Web data communicated to and from a Web server, text messages (also known as short message service or SMS), electronic mail messages, multimedia messages (also known as MMS), image files, video files, audio files, ring tones, streaming audio, streaming video, data feeds (e.g., podcasts), and so forth.

In this example, memory 530 stores drivers, such as I/O device drivers, and operating system programs (“OS”) 537. Memory 530 stores application programs (“apps”) 535 and data 536. Data may include application program data. A printer driver 538, which may be a program product as described herein above, may be stored in memory 530. Printer driver 538 may include an AI engine 115, as previously described herein.

I/O device drivers may include software routines accessed through microprocessor or microcontroller 525 or by an OS stored in memory 530. Apps, to communicate with devices such as the touch-sensitive input device 523 and keys and other user interface objects adaptively displayed on a display 521, may use one or more of such drivers.

Mobile device 520, such as a mobile or cell phone, includes a display 521. Display 521 may be operatively coupled to and controlled by a display controller 522, which may be a suitable microcontroller or microprocessor programmed with a driver for operating display 521.

Touch-sensitive input device 523 may be operatively coupled to and controlled by a touch-sensitive input device controller 524, which may be a suitable microcontroller or microprocessor. Along those lines, touching activity input via touch-sensitive input device 523 may be communicated to touch-sensitive input device controller 524. Touch-sensitive input device controller 524 may optionally include local storage 529.

Touch-sensitive input device controller 524 may be programmed with a driver or application program interface (“API”) for apps 535. An app may be associated with a service, as previously described herein, for use of a SaaS. One or more aspects of above-described apps may operate in a foreground or background mode.

Microprocessor or microcontroller 525 may be programmed to interface directly touch-sensitive input device 523 or through touch-sensitive input device controller 524. Microprocessor or microcontroller 525 may be programmed or otherwise configured to interface with one or more other interface device(s) of mobile device 520. Microprocessor or microcontroller 525 may be interconnected for interfacing with a transmitter/receiver (“transceiver”) 528, audio processing circuitry, such as an audio processor 513, and a position receiver 526, such as a global positioning system (“GPS”) receiver. An antenna 511 may be coupled to transceiver 528 for bi-directional communication, such as cellular and/or satellite communication.

Mobile device 520 may include a media recorder and processor 527, such as a still camera, a video camera, an audio recorder, or the like, to capture digital pictures, audio and/or video. Microprocessor or microcontroller 525 may be interconnected for interfacing with media recorder and processor 527. Image, audio and/or video files corresponding to the pictures, songs and/or video may be stored in memory 530 as data 536.

Mobile device 520 may include an audio processor 513 for processing audio signals, such as for example audio information transmitted by and received from transceiver 528. Microprocessor or microcontroller 525 may be interconnected for interfacing with audio processor 513. Coupled to audio processor 513 may be one or more speakers 514 and one or more microphones 519, for projecting and receiving sound, including without limitation recording sound, via mobile device 520. Audio data may be passed to audio processor 513 for playback. Audio data may include, for example, audio data from an audio file stored in memory 530 as data 536 and retrieved by microprocessor or microcontroller 525. Audio processor 513 may include buffers, decoders, amplifiers and the like.

Mobile device 520 may include one or more local wireless interfaces 510, such as a WIFI interface, an infrared transceiver, and/or an RF adapter. Wireless interface 510 may provide a Bluetooth adapter, a WLAN adapter, an Ultra-Wideband (“UWB”) adapter, and/or the like. Wireless interface 510 may be interconnected to an antenna 512 for communication. As is known, a wireless interface 510 may be used with an accessory, such as for example a hands-free adapter and/or a headset. For example, audible output sound corresponding to audio data may be transferred from mobile device 520 to an adapter, another mobile radio terminal, a computer, or another electronic device. In another example, wireless interface 510 may be for communication within a cellular network or another Wireless Wide-Area Network (WWAN).

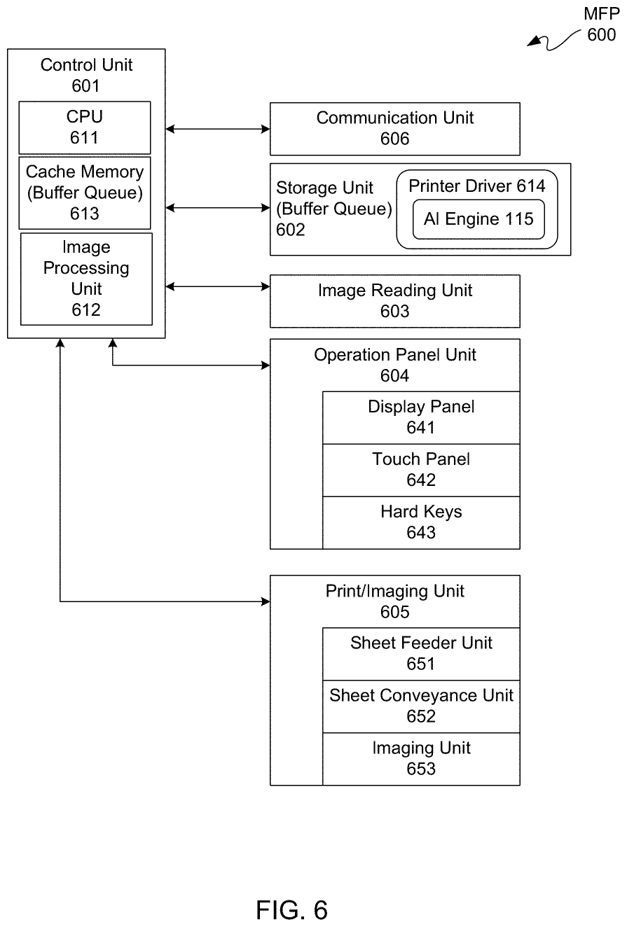

FIG. 6 is a block diagram depicting an example of a multi-function printer (MFP) 600. MFP 600 is provided for purposes of clarity by way of non-limiting example. MFP 600 is an example of an information processing system such as for handling a printer job as previously described.

MFP 600 includes a control unit 601, a storage unit 602, an image reading unit 603, an operation panel unit 604, a print/imaging unit 605, and a communication unit 606. Communication unit 606 may be coupled to a network for communication with other peripherals, mobile devices, computers, servers, and/or other electronic devices.

Control unit 601 may include a CPU 611, an image processing unit 612, and cache memory 613. Control unit 601 may be included with or separate from other components of MFP 600. Storage unit 602 may include ROM, RAM, and large capacity storage memory, such as for example an HDD or an SSD. Storage unit 602 may store various types of data and control programs, including without limitation a printer driver 614.

A printer driver 614 may be stored for a print server, where such printer driver may be downloaded to one or more other electronic devices. Such a printer driver 614 may include an AI engine 115, as previously described herein. A buffer queue may be located in cache memory 613 or storage unit 602.

Operation panel unit 604 may include a display panel 641, a touch panel 642, and hard keys 643. Print/imaging unit 605 may include a sheet feeder unit 651, a sheet conveyance unit 652, and an imaging unit 653.

Generally, for example, for an MFP a copy image processing unit, a scanner image processing unit, and a printer image processing unit may all be coupled to respective direct memory access controllers for communication with a memory controller for communication with a memory. Many known details regarding MFP 600 are not described for purposes of clarity and not limitation.

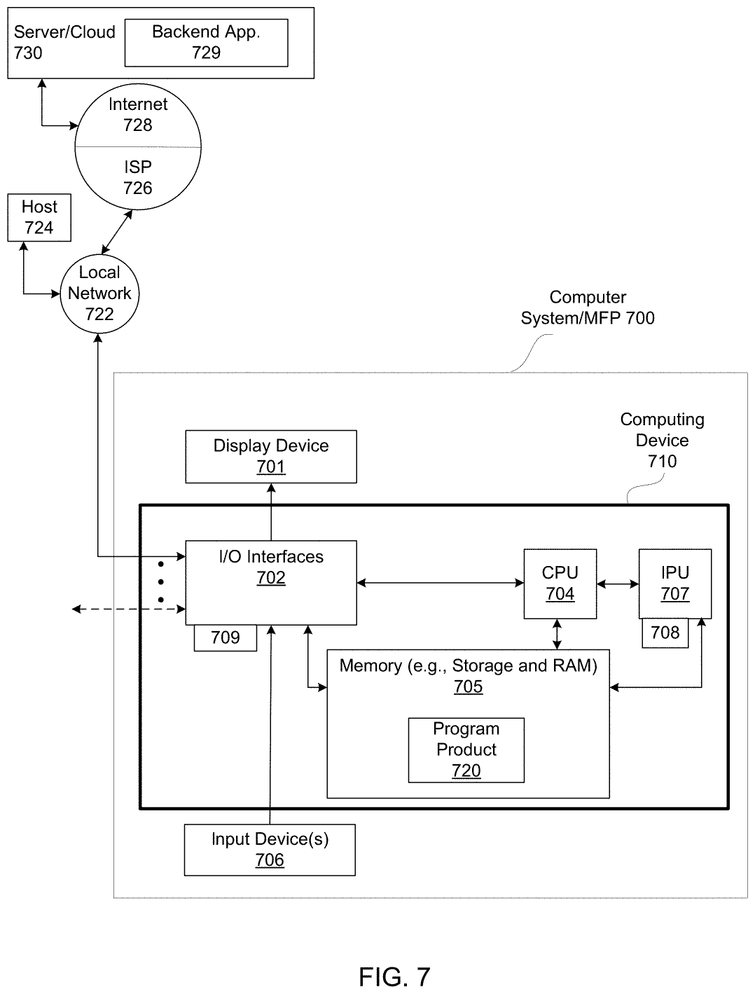

FIG. 7 is a block diagram depicting an example of a computer system 700 upon which one or more aspects described herein may be implemented. Computer system 700 may include a programmed computing device 710 coupled to one or more display devices 701, such as Cathode Ray Tube (“CRT”) displays, plasma displays, Liquid Crystal Displays (“LCDs”), Light Emitting Diode (“LED”) displays, light emitting polymer displays (“LPDs”) projectors and to one or more input devices 706, such as a keyboard and a cursor pointing device. Other known configurations of a computer system may be used. Computer system 700 by itself or networked with one or more other computer systems 700 may provide an information handling/processing system. Computer system 700 may be a portion of an MFP as described elsewhere herein.

Programmed computing device 710 may be programmed with a suitable operating system, which may include Mac OS, Java Virtual Machine, Real-Time OS Linux, Solaris, iOS, Darwin, Android Linux-based OS, Linux, OS-X, UNIX, or a Windows operating system, among other platforms, including without limitation an embedded operating system, such as VxWorks. Programmed computing device 710 includes a central processing unit (“CPU”) 704, one or more memories and/or storage devices (“memory”) 705, and one or more input/output (“I/O”) interfaces (“I/O interface”) 702. Programmed computing device 710 may optionally include an image processing unit (“IPU”) 707 coupled to CPU 704 and one or more peripheral cards 709 may be coupled to I/O interface 702. Along those lines, programmed computing device 710 may include graphics memory 708 coupled to optional IPU 707.

CPU 704 may be a type of microprocessor known in the art, such as available from IBM, Intel, ARM, and Advanced Micro Devices for example. CPU 704 may include one or more processing cores. Support circuits (not shown) may include busses, cache, power supplies, clock circuits, data registers, and the like.

Memory 705 may be directly coupled to CPU 704 or coupled through I/O interface 702. At least a portion of an operating system may be disposed in memory 705. Memory 705 may include one or more of the following: flash memory, random access memory, read only memory, magneto-resistive read/write memory, optical read/write memory, cache memory, magnetic read/write memory, and the like, as well as non-transitory signal-bearing media as described below. For example, memory 705 may include an SSD, which is coupled to I/O interface 702, such as through an NVMe-PCIe bus, SATA bus or other bus. Moreover, one or more SSDs may be used, such as for NVMe, RAID or other multiple drive storage for example.

I/O interface 702 may include chip set chips, graphics processors, and/or daughter cards, among other known circuits. In this example, I/O interface 702 may be a Platform Controller Hub (“PCH”). I/O interface 702 may be coupled to a conventional keyboard, network, mouse, camera, microphone, display printer, and interface circuitry adapted to receive and transmit data, such as data files and the like.

Programmed computing device 710 may optionally include one or more peripheral cards 709. An example of a daughter or peripheral card may include a network interface card (“NIC”), a display interface card, a modem card, and a Universal Serial Bus (“USB”) interface card, among other known circuits. Optionally, one or more of these peripherals may be incorporated into a motherboard hosting CPU 704 and I/O interface 702. Along those lines, IPU 707 may be incorporated into CPU 704 and/or may be of a separate peripheral card.

Programmed computing device 710 may be coupled to a number of client computers, server computers, or any combination thereof via a conventional network infrastructure, such as a company's Intranet and/or the Internet, for example, allowing distributed use. Moreover, a storage device, such as an SSD for example, may be directly coupled to such a network as a network drive, without having to be directly internally or externally coupled to programmed computing device 710. However, for purposes of clarity and not limitation, it shall be assumed that an SSD is housed in programmed computing device 710.

Memory 705 may store all or portions of one or more programs or data, including variables or intermediate information during execution of instructions by CPU 704, to implement processes in accordance with one or more examples hereof to provide program product 720. Program product 720 may be for implementing portions of process flows, as described herein. Additionally, those skilled in the art will appreciate that one or more examples hereof may be implemented in hardware, software, or a combination of hardware and software. Such implementations may include a number of processors or processor cores independently executing various programs, dedicated hardware and/or programmable hardware.

Along those lines, implementations related to use of computing device 710 for implementing techniques described herein may be performed by computing device 710 in response to CPU 704 executing one or more sequences of one or more instructions contained in main memory of memory 705. Such instructions may be read into such main memory from another machine-readable medium, such as a storage device of memory 705. Execution of the sequences of instructions contained in main memory may cause CPU 704 to perform one or more process steps described herein. In alternative implementations, hardwired circuitry may be used in place of or in combination with software instructions for such implementations. Thus, the example implementations described herein should not be considered limited to any specific combination of hardware circuitry and software, unless expressly stated herein otherwise.

One or more program(s) of program product 720, as well as documents thereof, may define functions of examples hereof and can be contained on a variety of non-transitory tangible signal-bearing media, such as computer- or machine-readable media having code, which include, but are not limited to: (i) information permanently stored on non-writable storage media (e.g., read-only memory devices within a computer such as CD-ROM or DVD-ROM disks readable by a CD-ROM drive or a DVD drive); or (ii) alterable information stored on writable storage media (e.g., floppy disks within a diskette drive or flash drive or hard-disk drive or read/writable CD or read/writable DVD).

Computer readable storage media encoded with program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. In implementations, information downloaded from the Internet and other networks may be used to provide program product 720. Such transitory tangible signal-bearing media, when carrying computer-readable instructions that direct functions hereof, represent implementations hereof.

Along those lines the term “tangible machine-readable medium” or “tangible computer-readable storage” or the like refers to any tangible medium that participates in providing data that causes a machine to operate in a specific manner. In an example implemented using computer system 700, tangible machine-readable media are involved, for example, in providing instructions to CPU 704 for execution as part of programmed product 720. Thus, a programmed computing device 710 may include programmed product 720 embodied in a tangible machine-readable medium. Such a medium may take many forms, including those describe above.

The term “transmission media”, which includes coaxial cables, conductive wire and fiber optics, including traces or wires of a bus, may be used in communication of signals, including a carrier wave or any other transmission medium from which a computer can read. Transmission media can also take the form of acoustic or light waves, such as those generated during radio-wave and infra-red data communications.

Various forms of tangible signal-bearing machine-readable media may be involved in carrying one or more sequences of one or more instructions to CPU 704 for execution. For example, instructions may initially be carried on a magnetic disk or other storage media of a remote computer. The remote computer can load the instructions into its dynamic memory and send such instructions over a transmission media using a modem. A modem local to computer system 700 can receive such instructions on such transmission media and use an infra-red transmitter to convert such instructions to an infra-red signal. An infra-red detector can receive such instructions carried in such infra-red signal and appropriate circuitry can place such instructions on a bus of computing device 710 for writing into main memory, from which CPU 704 can retrieve and execute such instructions. Instructions received by main memory may optionally be stored on a storage device either before or after execution by CPU 704.

Computer system 700 may include a communication interface as part of I/O interface 702 coupled to a bus of computing device 710. Such a communication interface may provide a two-way data communication coupling to a network link connected to a local network 722. For example, such a communication interface may be a local area network (“LAN”) card to provide a data communication connection to a compatible LAN. Wireless links may also be implemented. In any such implementation, a communication interface sends and receives electrical, electromagnetic or optical signals that carry digital and/or analog data and instructions in streams representing various types of information.

A network link to local network 722 may provide data communication through one or more networks to other data devices. For example, a network link may provide a connection through local network 722 to a host computer 724 or to data equipment operated by an Internet Service Provider (“ISP”) 726 or another Internet service provider. ISP 726 may in turn provide data communication services through a world-wide packet data communication network, the “Internet” 728. Local network 722 and the Internet 728 may both use electrical, electromagnetic or optical signals that carry analog and/or digital data streams. Data carrying signals through various networks, which carry data to and from computer system 700, are exemplary forms of carrier waves for transporting information.

Wireless circuitry of I/O interface 702 may be used to send and receive information over a wireless link or network to one or more other devices' conventional circuitry such as an antenna system, an RF transceiver, one or more amplifiers, a tuner, one or more oscillators, a digital signal processor, a CODEC chipset, memory, and the like. In some implementations, wireless circuitry may be capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, WIFI (such as IEEE 802.11a, IEEE 802.11b, IEEE 802.11g and/or IEEE 802.11n), Bluetooth, Wi-MAX, voice over Internet Protocol (VoIP), near field communication protocol (NFC), a protocol for email, instant messaging, and/or a short message service (SMS), or any other suitable communication protocol. A computing device can include wireless circuitry that can communicate over several different types of wireless networks depending on the range required for the communication. For example, a short-range wireless transceiver (e.g., Bluetooth), a medium-range wireless transceiver (e.g., WIFI), and/or a long range wireless transceiver (e.g., GSM/GPRS, UMTS, CDMA2000, EV-DO, and LTE/LTE-Advanced) can be used depending on the type of communication or the range of the communication.

Computer system 700 can send messages and receive data, including program code, through network(s) via a network link and communication interface of I/O interface 702. In the Internet example, a server 730 might transmit a requested code for an application program through Internet 728, ISP 726, local network 722 and I/O interface 702. A server/Cloud-based system 730 may include a backend application for providing one or more applications or services as described herein. Received code may be executed by processor 704 as it is received, and/or stored in a storage device, or other non-volatile storage, of memory 705 for later execution. In this manner, computer system 700 may obtain application code in the form of a carrier wave.

While the foregoing describes exemplary apparatus(es) and/or method(s), other and further examples in accordance with the one or more aspects described herein may be devised without departing from the scope hereof, which is determined by the claims that follow and equivalents thereof. Claims listing steps do not imply any order of the steps. Trademarks are the property of their respective owners.

What is claimed is:

1. A method for an information processing system, comprising:
collecting content of a web page by an artificial intelligence engine;
wherein the collecting comprises accessing at least one store of historical data by the artificial intelligence engine to parse components of the content;
parsing the components with a parser;
determining exclusion of one or more of the components responsive to the historical data by the artificial intelligence engine to provide page data; and
printing the page data.

2. The method according to claim 1, further comprising:
generating a preview window of the page data for display on a display device;
wherein the generating of the preview window comprises displaying content to be excluded in the printing.

3. The method according to claim 2, further comprising:
determining inclusion of one or more of other components responsive to the historical data by the artificial intelligence engine to provide the page data; and
wherein the preview window of the page data includes the one or more other components.

4. The method according to claim 3, wherein the historical data includes browsing history with respect to the web page.

5. The method according to claim 4, wherein the browsing history includes one or more of current data of the web page, type of the web page, or uniform resource locator information of the web page.

6. The method according to claim 4, wherein:
the historical data includes generative-learning data including user data; and
the user data includes current and prior selection data including type of objects removed and type of objects added.

7. The method according to claim 2, further comprising:
displaying the preview window on the display device with user selectable items; and
wherein the user selectable items are addable or removable from the page data responsive to cursor pointing device positioning and selection.

8. The method according to claim 7, further comprising:
processing demographic data including primitive types of the web page; and
updating the demographic data;
wherein the processing of the demographic data comprises:
collecting a primitive count for the web page; and
collecting a primitive percentage of a total amount of the web page consumed by primitives; and
updating a demographics history responsive to removal of one or more of the primitives.

9. The method according to claim 8, wherein:
the information processing system is a printing device; and
the method further comprises providing a print function call by a printer driver for printing the page data with driver-generated content.

10. The method according to claim 1, further comprising:
utilizing the historical data by the artificial intelligence engine to remove one or more primitives for providing a graphical view of each primitive remaining in the page data; and
presenting the graphical view on a display device in an application window.

11. A programmable electronic device, comprising:
a memory configured to store program code including a printer driver for a printing device;
a data store configured to store historical data;
a processor coupled to the memory and the data store, wherein the processor, in response to executing the printer driver, is configured to initiate operations to provide a print function call for printing page data with driver-generated content, wherein the page data is a subset of primitives of a web page; and
an artificial intelligence engine configured to collect content of the web page and remove one or more of the primitives of the web page to provide the subset thereof;
wherein the artificial intelligence engine is configured to access the data store to use the historical data to parse components of the content by types of the primitives.

12. The programmable electronic device according to claim 11, wherein the artificial intelligence engine is of the printer driver.

13. The programmable electronic device according to claim 11, wherein the artificial intelligence engine is of the printing device.

14. An information processing system, comprising:
a memory configured to store program code; and
a processor coupled to the memory, wherein the processor, in response to executing the program code, is configured to initiate operations for implementing a print of a portion of a web page, including:
collecting content of the web page by an artificial intelligence engine;
wherein the collecting comprises accessing at least one store of historical data by the artificial intelligence engine to parse components of the content;
parsing the components with a parser;
determining exclusion of one or more of the components responsive to the historical data by the artificial intelligence engine to provide page data; and
printing the page data as a portion of the web page.

15. The system according to claim 14, wherein the operations further comprise:
generating a preview window of the page data for display on a display device;
wherein the generating of the preview window comprises displaying content to be excluded in the printing.

16. The system according to claim 15, wherein the operations further comprise:
determining inclusion of one or more of other components responsive to the historical data by the artificial intelligence engine to provide the page data; and
wherein the preview window of the page data includes the one or more other components.

17. The system according to claim 16, wherein:
the historical data includes generative-learning data including user data; and
the user data includes current and prior selection data including type of objects removed and type of objects added.

18. The system according to claim 16, wherein the operations further comprise:
displaying the preview window on the display device with user selectable items; and
wherein the user selectable items are addable or removable from the page data responsive to cursor pointing device positioning and selection.

19. The system according to claim 18, wherein:
the information processing system is a printing device; and
the system further comprises providing a print function call by a printer driver for printing the page data with driver-generated content.

20. The system according to claim 14, wherein the operations further comprise:
utilizing the historical data by the artificial intelligence engine to remove one or more primitives for providing a graphical view of each primitive remaining in the page data; and
presenting the graphical view on the display device in an application window.
